(19) United States
(12) Patent Application Publication
(10) Pub. No.: US 2009/0289060 A1
(43) Pub. Date: Nov. 26, 2009

(54) WASTE BIN AND INNER BIN

(75) Inventor: Philippe Marie Gerard RENARD, Meeuwen-Gruitrode (BE)

Correspondence Address: SUGHRUE MION, PLLC, 2100 PENNSYLVANIA AVENUE, N.W., SUITE 800, WASHINGTON, DC, 20037, US

(73) Assignee: Brabantia Nederland B.V., Valkenswaard (NL)

(21) Appl. No.: 12/468,630

(22) Filed: May 19, 2009

(30) Foreign Application Priority Data
May 21, 2008 (NL) 2001600

(51) Int. Cl. B65D 21/02

(52) U.S. Cl. 220/23.88; 220/23.87

(57) ABSTRACT

The invention relates to a waste bin with a holder, and an inner bin. An inner bin can be accommodated in the holder for containing waste. The inner bin can be brought into a first, nominal position in the holder. The inner bin is supportable in a second, higher position with respect to the nominal position. The inner bin is provided with gripping means for supporting the inner bin in the second position, wherein the gripping means are arranged for engaging at least a portion of an upper edge of the holder.

The invention relates to a waste bin with a holder, wherein an inner bin can be accommodated in the holder for containing waste therein, wherein the inner bin can be brought into a first, nominal position in the holder, and wherein the inner bin is supportable in a second, higher position with respect to the nominal position.

In addition, the invention relates to an inner bin for a waste bin, wherein the inner bin comprises a bottom section with perimeter walls.

Such a waste bin with inner bin is disclosed in US 2006/0283862. The waste bin has a holder with a lid. A bin can be accommodated in a first position within the holder. In the first position a flange of the bin is supported by a rim of the holder. The bin may also be brought into a second, higher position. To this end a block is attached to a lower side in the holder. By lifting the bin up and tilting it slightly, the bin can be placed onto the block with its bottom section. Accordingly, the container can be brought into a second position so that a user can easily access the contents of the container.

A drawback of the known waste bin and of the known inner bin is that moving the bin from a first to a second position, and back again, is rather cumbersome. When moving the bin from the first position to the second position, the bin must be lifted up, then be slightly moved and/or tilted so that the bin rests with its bottom on the block. It may occur that the bin is not properly placed, so that it could fall back into the first position.

When moved from a second to a first position again, the bin must be lifted up slightly to be moved and/or tilted. The bin with the outer shell must then slide along the block in order to be brought back into a first position again. The user must be careful when doing this. It may occur that the bin cannot be moved or tilted to correct position so that the bucket is not able to be brought into the first position.

It is therefore an object of the present invention to provide a solution to or to mitigate at least one of the aforementioned drawbacks of the known waste bin and the known inner bin.

In an embodiment of the present invention the waste bin comprises an inner bin provided with gripping means for supporting the inner bin in the second position, wherein the gripping means are arranged for engaging at least one portion of an upper edge of the holder. In this manner, an inner bin can be suspended on the holder. The gripping means provided on the inner bin are visible to the user when the inner bin is brought into a second position. This makes it is easier for a user to move the inner bin between a first and a second position, because the user can easily see when the gripping means are in an operable or inoperable position.

In one embodiment, a provision is made for at least two inner bins, wherein the assembly of the at least two inner bins can be accommodated in the holder. By using multiple bins, it is possible to separate waste to be collected. A first inner bin can be used to include any normal waste to be disposed of, while the second inner bin is used to dispose of vegetable, fruit and garden waste. It is possible to use more than two inner bins, so that an additional inner bin can be used, for example, for the disposal of waste paper or other items. Because the gripping means are provided on the inner bin itself, no complex construction in the holder is required to ensure that each bin can be moved independently to a higher position. Moreover, a user can easily lift each inner bin of the assembly from a nominal position into to a higher position, and back again.

The second, higher position may be a fixed position. In this manner, for example, it is possible to place one of the at least two bins in a higher position so that one of the two bins can be easily accessed. This makes it easier to separate the waste. It is also possible to have the inner bin closable in a fixed position, by means of a matching lid.

In one embodiment, the holder comprises a collar close to an upper edge, wherein the inner bin is provided on the upper side with a flange, which, in a nominal position of the inner bin, rests at least partially on the collar. In this manner, the flange of the inner bin closes off the inside of the holder. This prevents rubbish from disappearing into the holder. In addition, the collar ensures, in conjunction with the flange, that the inner bin remains stable when in a nominal position.

In the collar of the waste bin, at least one recess can be provided so that the inner bin can be easily gripped by a user. The recess ensures that the inner bin can be easily gripped at the flange so that the inner bin can be easily lifted up to the higher position. In one embodiment, two recesses are formed in the collar. This enables a user to lift the inner bin using both hands. If two or more bins are used, the recess may be formed in such a manner that a recess can be used to grip at least two bins.

However, it is also possible for the inner bin to be provided with a handle so that the inner bin can be easily lifted up by a user. This embodiment is relatively cheap, since no special collar needs to be provided on the holder. The handle can be movably attached to the inner bin. It is possible that the handle rests on the rim of the inner bin when the handle is not used.

In one embodiment, the gripping means are disposed at a distance from an upper edge of the inner bin, whereby the distance corresponds to a difference in height to be bridged between the nominal position and the higher position of the inner bin. Because the distance between the upper edge and the gripping means corresponds to the difference in height to be bridged, it is quite easy for a designer to determine the position of the gripping means. The distance must be sufficiently great, to enable a user to easily remove or exchange a waste bag placed in the inner bin. However, the distance may not be too great or too small. If the distance is too short, this will prevent the user from properly removing and/or exchanging the refuse bag. Conversely, if the distance is too big, this would require the user to lift the inner bin up too high before it can be placed in the second position. The distance D is preferably between 30 and 130 cm.

It is also possible to provide adjusting means for adjusting the distance of the gripping means with respect to the upper edge of the inner bin. This enables a user to adjust the height himself, as so desired.

In one embodiment of the waste bin, the gripping means are provided on a jacket portion of the inner bin. Placing the gripping means on the outer jacket of the inner bin ensures that the inner bin can be placed in the higher position in a stable manner. In addition, an embodiment as such ensures a sturdy construction of the gripping means, so that these are relatively difficult to damage/break.

In one embodiment, the gripping means comprise a hook-shaped component. The hook-shaped component is arranged to grip over the rim of the holder so that the inner bin can be held in a stable manner in a second, higher position. Such an embodiment is relatively cheap. In addition, the hook-shaped component is relatively sturdy and resistant to wear.

In one embodiment, the gripping means extend less far in a radial, outwardly direction than the flange of the inner bin. This provides a sufficient amount of space in the inner bin for it to be easily placed in the holder. This is not impeded in any way by the gripping means.

It is possible to provide the gripping means with guide elements for guiding the movement of the inner bin when moved between a nominal and a higher position. The guide elements ensure that the inner bin is easily movable between the two positions. Notably, the guide elements ensure that the gripping means cannot easily jam in the holder. In addition, the guide elements ensure the further sturdiness of the gripping means. The guide elements can be formed in such a manner that these only guide the movement when the inner bin is lifted upwards. This enables a user to easily remove the inner bin and then place the inner bin on the outer bin relatively simply, without the inner bin being accidentally moved into a nominal position.

In one embodiment the inner bins taper. In this manner, a self-aligning effect is obtained when the inner bin is placed into the holder. In addition, such an embodiment ensures that the inner bins can be nested. This enables a number of inner bins to be stored jointly, in order to save space. This makes the gripping means advantageous. If the gripping means are provided on the outer jacket of the inner bin, these will ensure that the stackable inner bins are not stacked inside of each other to the full extent. This prevents stacked inner bins from being too tightly nested, which then makes it difficult for them to be separated. Applying the gripping means prevents the inner bins from being stacked too tightly. This is particularly advantageous in the production of the inner bins, where the easy separation of the inner bins may also speed up the production of the inner bins.

According to another embodiment of the invention, an inner bin is provided wherein the inner bin is equipped on its outer jacket with gripping means. The gripping means ensure that the inner bin can be moved from a nominal to a higher position.

In one embodiment of the inner bin, the perimeter walls of the inner bin run tapered in an upward direction. Such an embodiment ensures that the inner bins can be nested.

In one embodiment, at least two inner bins can be stacked in a nested fashion so that, when stacked, the gripping means of an upper inner bin engage the upper rim of an inner bin in a lower position. The gripping means provided on the outer jacket of the inner bin can be placed in such a manner that they ensure that the inner bin can only be stacked in a lower inner bin to a certain distance. This prevents bins from being stacked inside each other too tightly. Stacking the inner bins inside each other is done quite frequently, especially during the production of the inner bins. It sometimes occurs that the inner bins stick too tightly together, which makes them relatively difficult to separate. Quite often, special equipment is needed to separate the bins from each other. This makes the production of the inner bin relatively time-consuming and expensive. Applying the gripping means prevents inner bins being placed too tightly inside one another. This is particularly advantageous in the production of the inner bins, where the easy separation of the inner bins may speed up the production of the inner bins.

It is possible to provide the gripping means of the inner bin with guide elements. The guide element may be arranged in such a manner that the inner bin can be easily moved in a holder. In addition, the guide elements ensure, in the case of a tapered inner bin, that when the containers are placed inside one another, the inner bin maintains a relatively loose fit when it rests in place within a lower inner bin. This ensures that the inner bins are relatively easy to separate from one another.

One of the embodiments of the present invention will be described in more detail in the following figures. It will be obvious to a skilled person that the invention is not limited to this embodiment, but that other equivalent measures are conceivable, without departing from the scope of the invention. In the figures:

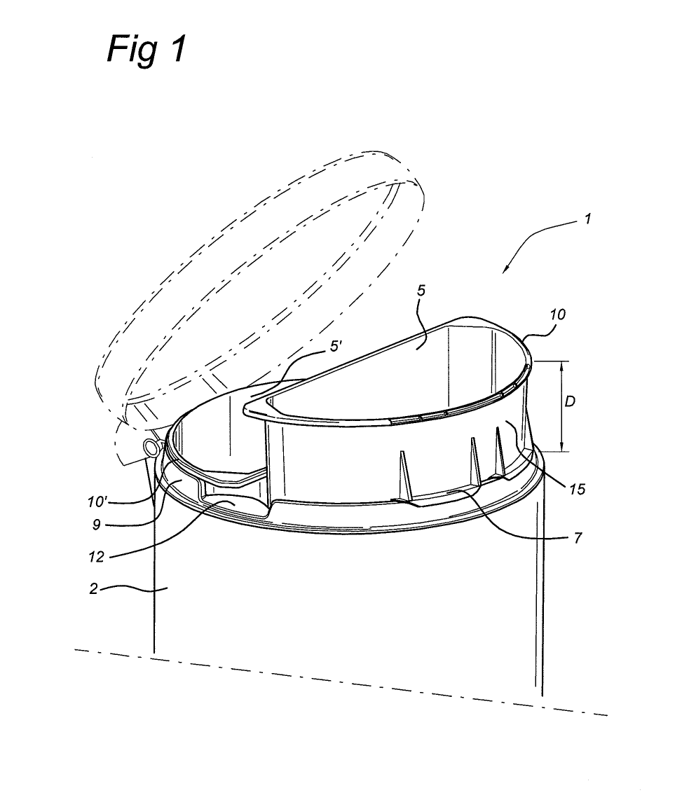

FIG. 1 shows a view in perspective of an embodiment of a waste bin according to the present invention;

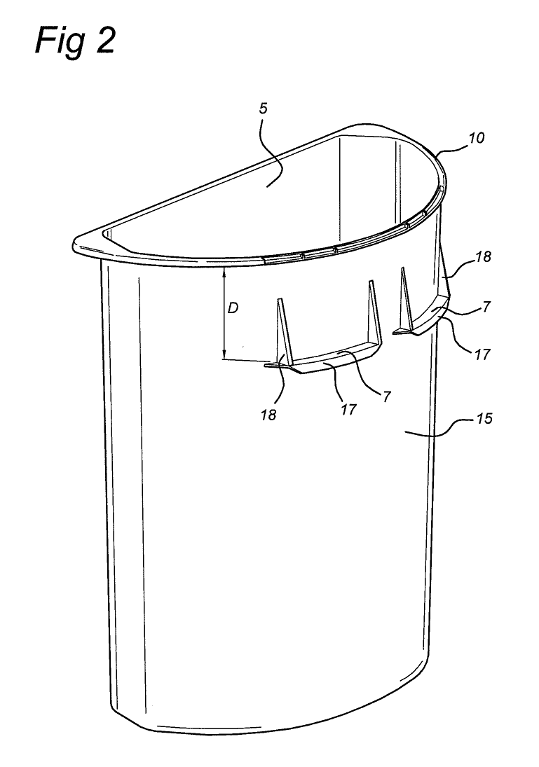

FIG. 2 shows a view in perspective of an embodiment of an inner bin for a waste bin according to the present invention;

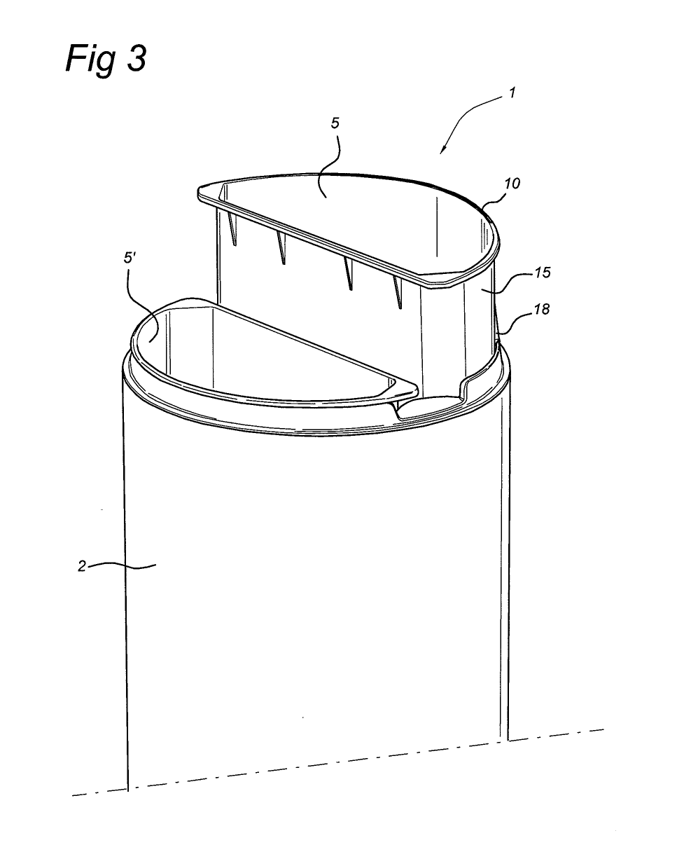

FIG. 3 shows a view in perspective of an inner bin in a nominal position, and an inner bin in a higher position;

FIG. 2 shows the waste bin 1 with a holder 2. The waste bin may be provided with a lid in a manner well-known to those skilled in the art. The holder is provided with a collar 9, wherein a recess 12 is formed in a portion of the collar 9. It is possible to construct the holder 2 without collar 9, or alternatively, to provide the collar 9 without a recess 12. In the embodiment shown, two inner bins 5, 5′ are incorporated in the holder, wherein each inner bin 5, 5′ is provided on an upper side thereof with a flange 10, 10′. A first inner bin 5′ is thereby incorporated in the holder in a nominal position. A second inner bin 5 is incorporated in the holder 2 in a higher position with respect to the nominal position. The second inner bin 5 is thereby supported by gripping means 7 arranged on the collar 9 of the holder 2.

The holder in the embodiment shown is cylindrical. The inner bins 5, 5′ have a semi-cylindrical shape, so that the joint arrangement of the two inner bins 5, 5′ has essentially the same cylindrical shape as the holder. However, the assembly is designed a little smaller, so that the inner bins 5, 5′ can be easily accommodated in the holder. It is possible to design the holder and the corresponding inner bins in a shape that differs from that of a cylinder. Thus, the holder may have the shape of a prism, with three or more sides. It is also possible to provide the holder with three or more inner bins, as long as the arrangement of inner bins can be accommodated in the holder.

FIG. 2 shows one of the inner bins 5, 5′ of FIG. 1 in more detail. In the embodiment shown, two gripping means 7 are provided on an outer jacket 15 of the inner bin 5. The gripping means 7 are arranged along the perimeter at a certain distance from one another. In an embodiment not shown, the inner bin is provided with one or more gripping means, arranged along a portion of the perimeter of the inner bin. In the embodiment shown, the gripping means 7 are provided with a stop means 18 and a substantially hook-shaped component 17. The stop means 18 is disposed substantially perpendicular to the outer jacket 15 of the inner bin 5, 5′, and extends to a certain distance outwardly. An end of the stop means 18 is provided with the hook-shaped component 17. The hook-shaped component 17 is arranged substantially parallel to the inner jacket 15 so that the gripping means can engage the upper edge of the holder in a suitable manner. The gripping means have a distance D with respect to the upper edge of the inner bin 5. On an upper side of each gripping means 7 two guide elements 18 are provided, which extend upwardly. Here, a rim of the guide elements runs in a tapered fashion from an outer side of the stop means in the direction of the inner shell.

As is shown in FIG. 3 is shown, each of the inner bins 5, 5′ shown in FIG. 1 can be moved by a user from a nominal position N to a higher position H. To do this, the user can grip the inner bin 5, 5′ near to the recess 12 of the collar 9 of the holder 2. Subsequently, the inner bin can easily be lifted up, until the gripping means 7 extend above the upper edge of the holder 2. The guide elements 18 ensure, when the inner bin 5, 5′ is moved upwards, that it cannot be hindered in any way by the holder 2. Subsequently, the side of the inner bin 5, 5′ on which the gripping means are provided can be moved in a radial direction. The hook-shaped parts 17 will then be moved over a rim of the holder 2, after which the gripping means can be placed supportably on the rim of the holder 2. The inner bin is then disposed in a higher position H. In this position, it is easier for a user to reach the contents of the inner bin. This also makes it possible for the user to remove a refuse bag placed in the inner bin 5, 5′ and attached around the flange 10, 10′ of the inner bin in order to insert and attach a new refuse bag in a similar fashion.

The present invention is not limited to the preferred embodiments described herein. The rights requested are defined by the following claims, within the scope of which numerous modifications are conceivable.

1. Waste bin with a holder, wherein an inner bin can be accommodated in the holder for containing waste therein, wherein the inner bin is provided on the upper side with a flange and can be brought into a first, nominal position in the holder and wherein the inner bin is provided with gripping means are provided for supporting the inner bin in a second, higher position with respect to the nominal position, wherein the gripping means are arranged for gripping at least a portion of an upper edge of the holder, wherein the gripping means comprise a substantially hook-shaped component that extends less far in a radial, outwardly direction than the flange of the inner bin.

2. Waste bin according to claim 1, wherein at least two inner bins are provided, wherein the joint assembly of the at least two inner bins can be incorporated essentially one next to the other in the holder.

3. Waste bin according to claim 2, wherein the at least two inner bins are displaceable independent from one another between the nominal position and higher position.

4. Waste bin according to claim 1, wherein the holder comprises a collar, wherein the flange in an nominal position of the inner bin rests at least partially on the collar.

5. Waste bin according to claim 4, wherein a recess is formed in the collar, such that the inner bin can be easily gripped by a user.

6. Waste bin according to claim 1, wherein the gripping means are disposed at a distance from an upper edge of the inner bin, wherein the distance corresponds to a difference in height to be bridged between the nominal position and the higher position of the inner bin.

7. Waste bin according to claim 1, wherein adjusting means are provided for adjusting the distance of the gripping means with respect to the upper edge of the inner bin.

8. Waste bin according to claim 1, wherein the gripping means are provided on a jacket portion of the inner bin.

9. Waste bin according to claim 1, wherein the gripping means are provided with guide elements for guiding the movement of the inner bin when this is moved between a nominal and a higher position.

10. Inner bin for use in a waste bin with a holder as claimed in any of the preceding claims, wherein the inner bin comprises a bottom section with perimeter walls and a flange that is provided at an upper side of the inner bin, wherein the inner bin can be placed in the holder of the waste bin, wherein the inner bin is provided on an outer jacket thereof with gripping means so as to support the inner bin on at least an upper edge of the holder, wherein the gripping means comprise a substantially hook-shaped component that extends less far in a radial, outwardly direction than the flange of the inner bin.

11. Inner bin according to claim 10, wherein the perimeter walls of the inner bin run tapered in an upward direction.

12. Inner bin according to claim 11, wherein an assembly of at least two inner bins can be stacked in a nested fashion, wherein, when stacked, the gripping means of an upper inner bin engage the upper edge of a lower inner bin.

13. Inner bin according to claim 10, wherein the gripping means are provided with guide elements.

14. Inner bin according to claim 10, wherein the inner bin is provided with a handle.
